(19) United States
(12) Patent Application Publication
(10) Pub. No.: US 2002/0185875 A1
(43) Pub. Date: Dec. 12, 2002

(54) Parts suction head of surface mount device

(75) Inventor: Dong June Kim, Kyungki-do (KR)

Correspondence Address: FLESHNER & KIM, LLP, P.O. Box 221200, Chantilly, VA, 20153-1200, US

(73) Assignee: MIRAE CORPORATION

(21) Appl. No.: 10/020,937

(22) Filed: Dec. 19, 2001

(30) Foreign Application Priority Data
Jun. 12, 2001 (KR) 2001-32969

(51) Int. Cl. B25J 15/06

(52) U.S. Cl. 294/64.1

(57) ABSTRACT

A parts suction head includes: a motor for generating a rotary force and transmitting the rotary force to a rotation central axis; a ball spline unit for performing a rotation movement and vertical reciprocation; a rotation shaft unit moved in a vertical direction and rotated, for sucking or mounting a parts; and a plurality of couplings for transmitting the rotary force of the rotation central axis of the motor to the ball spline unit, and transmitting the rotary force of the ball spline unit to the rotation shaft unit. Therefore, the rotation central axes can be easily aligned by connecting the motor, the ball spline unit and the rotation shaft unit by using the couplings.

### BACKGROUND OF THE INVENTION

1. Field of the Invention

The present invention relates to a parts suction head of a surface mount device, and in particular to an improved parts suction head for sucking a component in a surface mount device and mounting the component on a printed circuit board which has an improved precision and which can be easily assembled by using a plurality of couplings.

2. Description of the Background Art

A surface mount device is used to rapidly precisely mount a plurality of components on a printed circuit board. The surface mount device for rapidly precisely mounting parts on the printed circuit board includes an X-Y gantry, a printed circuit board conveyor, a component feeder and a head unit. The head unit is installed in the X-Y gantry, for mounting the parts on the printed circuit board transferred to a parts mounting operation position by the printed circuit board conveyor. The head unit receives the parts from the parts feeder to be mounted on the printed circuit board.

The head unit sucking the parts supplied from the parts feeder includes a plurality of parts sucking heads. Each of the respective parts suction heads includes a motor, a ball spline and a socket unit. The parts suction head composed of a motor, a ball spline unit and a rotation shaft unit will now be described in detail with reference to the accompanying drawings.

FIG. 1 is a side view illustrating a conventional parts suction head of a surface mount device. Referring to FIG. 1, the parts suction head 100 includes a motor 10, a ball spline unit 20 and a rotation shaft unit 30. A rotation central axis 11 of the motor 10 is connected to one end portion of the ball spline unit 20. The other end portion of the ball spline unit 20 is connected to the rotation shaft unit 30. The ball spline unit 20 connected to the rotation shaft unit 30 includes a ball spline 21 and a ball spline nut 22. The ball spline unit 20 performs a rotation movement due to a rotary force generated in the motor 10, and performs reciprocation in a vertical direction. When the parts suction head 100 is moved in a vertical direction, the ball spline unit 20 prevents a load of the motor 10 from being transmitted to the rotation shaft unit 30.

The rotation shaft unit 30 connected to the other end portion of the ball spline unit 20 performing the rotation movement and the reciprocation includes a rotation shaft 31, a socket 32, an LM guide 33, a moving block 34 and flanges 35. The socket 32 is installed at one end portion of the rotation shaft 31, and the moving block 34 is disposed at the outer portion thereof. The flanges 35 are provided to both end portions of the moving block 34. Here, the rotation shaft 31 is assembled in the moving block 34. The LM guide 33 is positioned on the rear surface of the moving block 34 in order to vertically reciprocate the rotation shaft 31 assembled in the moving block 34.

The LM guide 33 includes a moving member 33a and a fixing member 33b. The moving member 33a is fixed to the rear surface of the moving block 34, for guiding the vertical reciprocation of the rotation shaft 31, the ball spline 21 and the moving block 34 along the fixing member 33b, and mounting the sucked parts on the printed circuit board. When the parts to be mounted on the printed circuit board is not precisely sucked to the parts suction head, the rotation shaft 31 is rotated by the motor 10 in a predetermined radius, thereby correcting suction of the parts.

In the conventional parts suction head 100 for mounting the parts supplied from the parts feeder (not shown) on the printed circuit board, the rotation central axis 11 of the motor 10 and the ball spline unit 20 are connected by the coupling 1, and the ball spline unit 20 and the rotation shaft unit 30 are directly connected.

There is a problem in the conventional art, when the parts suction head having the motor, the ball spline unit and the rotation shaft unit is assembled by using one coupling, the central axes of the motor, the ball spline unit and the rotation shaft unit should be aligned to suck the parts and precisely mount the parts on the printed circuit board. Also, when any of the motor, the ball spline unit and the rotation shaft unit has a processing error, it is difficult to assemble the parts suction head.

### SUMMARY OF THE INVENTION

Accordingly, it is a primary object of the present invention to provide a parts suction head of a surface mount device which has a motor, a ball spline unit and a rotation shaft unit, and which is assembled by aligning central axes of the motor and the rotation shaft by using a plurality of couplings.

It is another object of the present invention to easily assemble a parts suction head by aligning central axes of a motor and a rotation shaft. In order to achieve the above-described object of the invention, there is provided a parts suction head of a surface mount device comprising: a motor for generating a predetermined rotary force and transmitting the rotary force to a rotation central axis; a ball spline unit for performing a rotation movement and vertical reciprocation by the rotary force generated from the motor; a rotation shaft unit moved in a vertical direction and rotated, for sucking or mounting a parts; and coupling means for transmitting the rotary force of the rotation central axis of the motor to the ball spline unit, and transmitting the rotary force of the ball spline unit to the rotation shaft unit.

### BRIEF DESCRIPTION OF THE DRAWINGS

The present invention will become better understood with reference to the accompanying drawings which are given only by way of illustration and thus are not limitative of the present invention, wherein:

FIG. 1 is a side view illustrating a conventional parts suction head of a surface mount device;

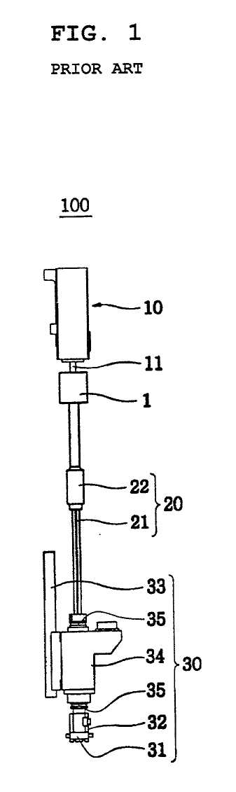

FIG. 2 is an exploded perspective view illustrating a parts suction head of a surface mount device in accordance with the present invention;

FIG. 3 is a perspective view illustrating an assembled state of the parts suction head of FIG. 2;

FIG. 4 is a side view illustrating the parts suction head of FIG. 3; and

FIG. 5 is a cross-sectional view illustrating the parts suction head of FIG. 3, taken along lines A-A′.

### DETAILED DESCRIPTION OF THE PREFERRED EMBODIMENTS

A parts suction head of a surface mount device in accordance with a preferred embodiment of the present invention will now be described in detail with reference to the accompanying drawings.

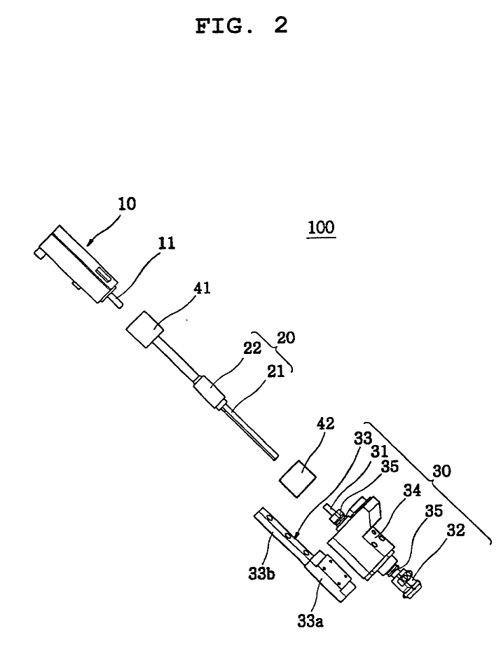

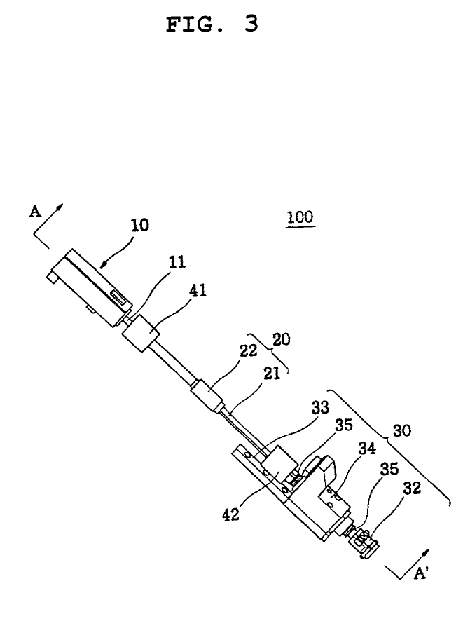

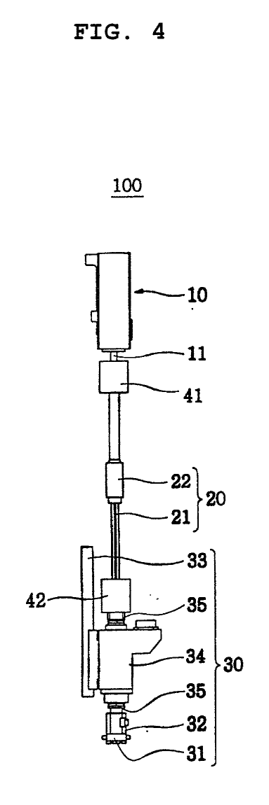

FIG. 2 is an exploded perspective view illustrating the parts suction head of the surface mount device in accordance with the present invention, FIG. 3 is a perspective view illustrating an assembled state of the parts suction head of FIG. 2, and FIG. 4 is a side view illustrating the parts suction head of FIG. 3. As illustrated in FIGS. 2 to 4, the parts suction head includes: a motor 10 for generating a rotary force and transmitting the rotary force to a rotation central axis 11; a ball spline unit 20 for performing a rotation movement and vertical reciprocation; a rotation shaft unit 30 moved in a vertical direction and rotated, for sucking or mounting a parts (not shown); and a plurality of couplings 41 and 42 for connecting the rotation central axis 11 of the motor 10 to one end portion of the ball spline unit 20, transmitting the rotary force of the rotation central axis 11 of the motor 10 to the ball spline unit 20, and connecting the other end portion of the ball spline unit 20 to the rotation shaft unit 30 to transmit the rotary force of the ball spline unit 20 to the rotation shaft unit 30.

The structure and operation of the present invention will now be explained in more detail.

The parts suction head of the surface mount device includes the motor 10, the ball spline unit 20, the rotation shaft unit 30 and the plurality of couplings 41 and 42.

The motor 10 generates a rotary force for rotating the rotation shaft 31 of the rotation shaft unit 30 and thereafter, the rotary force is transmitted to the ball spline unit 20 by the rotation central axis 11 of the motor 10. The ball spline unit 20 receiving the rotary force from the rotation central axis 11 includes a ball spline 21 and a ball spline nut 22. The ball spline 21 is connected to the inner portion of the ball spline nut 22, for performing the rotation movement due to the rotary force generated in the motor 10, and also performing the reciprocation in a vertical direction. When the parts suction head 100 is moved in a vertical direction, the ball spline unit 20 prevents a load of the motor 10 from being transmitted to the rotation shaft unit 30.

The rotation shaft unit 30 is connected to the other end portion of the ball spline unit 20 performing the rotation movement and the reciprocation. The rotation shaft unit 30 includes a rotation shaft 31, a socket 32, an LM guide 33, a moving block 34 and flanges 35. The socket 32 is installed at one end portion of the rotation shaft 31, and the moving block 34 is disposed at the outer portion thereof. The flanges 35 are provided to both end portions of the moving block 34. Here, the rotation shaft 31 is assembled in the moving block 34. The LM guide 33 is positioned on the rear surface of the moving block 34 in order to vertically reciprocate the rotation shaft 31 assembled in the moving block 34.

The LM guide 33 includes a moving member 33a and a fixing member 33b. The moving member 33a is fixed to the rear surface of the moving block 34, for guiding the vertical reciprocation of the rotation shaft 31, the ball spline 21 and the moving block 34 along the fixing member 33b, and mounting the adsorbed component on the printed circuit board. When the parts to be mounted on the printed circuit board is not precisely sucked to the parts suction head, the rotation shaft 31 is rotated by the motor 10 in a predetermined radius, thereby correcting suction of the parts.

In order to correct a suction state and position of the parts, the rotation shaft unit 30 is connected to the ball spline unit 20 to rotate the rotation shaft 31, and then connected to the rotation central axis 11 of the motor 10 through the ball spline unit 20. The coupling means is used to connect the rotation central axis 11 of the motor 10 to one end portion of the ball spline unit 20, or to transmit the rotary force of the ball spline unit 20 to the rotation shaft unit 30.

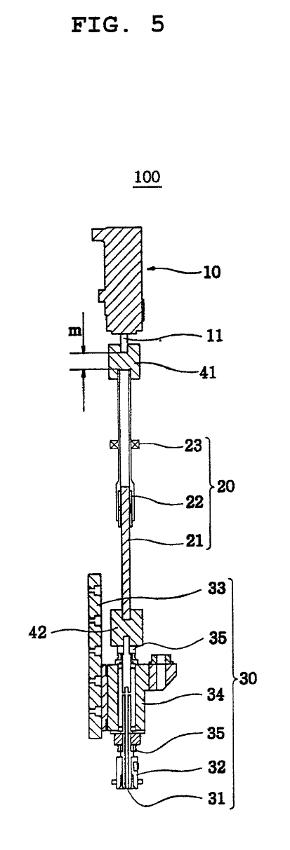

The coupling means includes a first coupling 41 and a second coupling 42. The first coupling 41 connects the rotation central axis 11 of the motor 10 to one end portion of the ball spline unit 20, and the second coupling 42 connects the other end portion of the ball spline unit 20 to the rotation shaft unit 30, thereby transmitting the rotary force of the motor 10 to the rotation shaft 31. As shown in FIG. 5, a bearing 23 is provided to the ball spline nut 22 to restrict a rotation radius of the rotation shaft 31 receiving the rotary force.

As depicted in FIG. 5, when the rotation central axis 11 of the motor 10 and the ball spline nut 22 of the ball spline unit 20 are inserted, the first coupling 41 for transmitting the rotary force of the motor 10 to the rotation shaft 31 is connected to maintain a predetermined distance (m). In addition, when the other end portion of the ball spline 21 of the ball spline unit 20 and the rotation shaft 31 of the rotation shaft unit 30 are inserted, the second coupling 42 is connected to maintain a predetermined distance (m). The ball spline unit 20 transmits the rotary force of the motor 10 to the rotation shaft unit 30, or prevents the load of the motor 10 from being directly transmitted to the rotation shaft unit 30.

In accordance with the present invention, the rotation central axes of the motor and the rotation shaft unit are aligned regardless of the rotation central axis of the ball spline unit, by connecting the motor, the ball spline unit and the rotation shaft unit by using the plurality of couplings, which simplifies an assembly process of the parts suction head. Moreover, even if the rotation central axes of the motor and the rotation shaft unit are not precisely aligned, the rotation shaft can be rotated synchronously with the rotation of the motor.

As discussed earlier, the rotation central axes can be easily aligned by connecting the motor, the ball spline unit and the rotation shaft unit by using the plurality of couplings. As a result, an assembly process of the parts suction head can be simplified.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. A parts suction head of a surface mount device comprising:
a motor for generating a predetermined rotary force and transmitting the rotary force to a rotation central axis;
a ball spline unit for performing a rotation movement and vertical reciprocation by the rotary force generated from the motor;
a rotation shaft unit moved in a vertical direction and rotated, for sucking or mounting a parts; and
coupling means for transmitting the rotary force of the rotation central axis of the motor to the ball spline unit, and transmitting the rotary force of the ball spline unit to the rotation shaft unit.

2. The parts suction head of a surface mount device according to claim 1, wherein the coupling means comprises:
a first coupling for connecting the rotation central axis of the motor to one end portion of the ball spline unit; and
a second coupling for connecting the other end portion of the ball spline unit to the rotation shaft unit.

3. The parts suction head of a surface mount device according to claim 2, wherein when the rotation central axis of the motor and the ball spline nut of the ball spline unit are inserted, the first coupling for transmitting the rotary force of the motor to the rotation shaft is connected to maintain a predetermined distance (m).

4. The parts suction head of a surface mount device according to claim 2, wherein when the other end portion of the ball spline of the ball spline unit and the rotation shaft of the rotation shaft unit are inserted, the second coupling is connected to maintain a predetermined distance (m).

5. The parts suction head of a surface mount device according to claim 1, wherein a bearing is provided to the ball spline nut to restrict a rotation radius of the rotation shaft receiving the rotary force.
